(19) United States
(12) Patent Application Publication
(10) Pub. No.: US 2013/0156960 A1
(43) Pub. Date: Jun. 20, 2013

(54) ORGANIC-INORGAIC HYBRID POLYAMIC ESTER, METHOD OF FABRICATING THE SAME, AND METHOD OF FABRICATING A FILM THEREOF

(71) Applicants: Seung Koo PARK, Daejeon (KR); Jeong Ik LEE, Gyeonggi-do (KR); Doo-Hee CHO, Daejeon (KR); Hye Yong CHU, Daejeon (KR); Chul Woong JOO, Seoul (KR)

(72) Inventors: Seung Koo PARK, Daejeon (KR); Jeong Ik LEE, Gyeonggi-do (KR); Doo-Hee CHO, Daejeon (KR); Hye Yong CHU, Daejeon (KR); Chul Woong JOO, Seoul (KR)

(73) Assignee: ELECTRONICS AND TELECOMMUNICATIONS RESEARCH INSTITUTE, Daejeon (KR)

(21) Appl. No.: 13/619,706

(22) Filed: Sep. 14, 2012

(30) Foreign Application Priority Data
Dec. 14, 2011 (KR) 10-2011-0134469

(51) Int. Cl. C08L 77/06; B05D 3/02; B05D 7/24

(52) U.S. Cl. 427/385.5; 525/436

(57) ABSTRACT

Provided are organic-inorganic hybrid polyamic ester, method of fabricating the same, and method of fabricating a film thereof. The polyamic ester is formed by chemically reacting an inorganic precursor containing inorganic and/or metal element with a polyamic acid having two carboxyl acid of good reactivity per a polymer repeating unit. The inorganic alkoxide is hydrolyzed to be the corresponding inorganic hydroxide. The hydroxyl group is reacted with the carboxylic acid of the polyamic acid and with the hydroxyl group of the other inorganic hydroxide. Therefore, the polyamic ester can steadily include more inorganic materials. The content amount of the inorganic material is relatively high, so that the polyamic ester may have superior refractive index, chemical and heat resistances.

### CROSS-REFERENCE TO RELATED APPLICATIONS

This U.S. non-provisional patent application claims priority under 35 U.S.C. §119 of Korean Patent Application No. 10-2011-0134469, filed on Dec. 14, 2011, the entire contents of which are hereby incorporated by reference.

### BACKGROUND

The present disclosure herein relates to organic-inorganic hybrid polyamic ester, method of fabricating the same, and method of fabricating a film thereof.

In order to improve refractive index, chemical and heat resistances of polymer, there have been studied a method of introducing inorganic material into the polymer. As the methods, an inorganic material is simply mixed with polymer to form a composite material and an inorganic material is chemically reacted to the polymer to make organic-inorganic hybrid polymers. In the case of the composite material, there may occur a phase separation between the polymer and the inorganic material due to the characteristic difference between them. In order to increase of portion of the inorganic material in a polymer matrix, the inorganic material is chemically treated to increase affinity with the polymer. Alternatively, a compound having a chemical structure similar with an inorganic material is chemically introduced into a polymer so that the polymer is suitable for dispersion of the inorganic material. However, there is a limitation with selection of a monomer when synthesizing a polymer in order to fabricate an organic-inorganic hybrid polymer.

### SUMMARY

The present disclosure provides an organic-inorganic hybrid polymer material having superior refractive index, chemical and heat resistances.

The present disclosure provides a method of fabricating an organic-inorganic hybrid polymer material, capable of easily embodied and having a high degree of synthesis freedom.

Furthermore, the present disclosure provides a method of fabricating a film having superior refractive index, chemical and heat resistances.

Embodiments of the inventive concept provide an organic-inorganic hybrid polyamic ester including the following chemical formula 1.

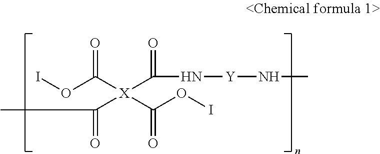

In the chemical formula 1, the X is an alicyclic compound or an aromatic compound, the Y is an aliphatic compound or an aromatic compound, and the I is at least one out of an inorganic element or a metal element.

The I may be at least one selected from a group consisting of titanium oxide, silicon oxide and zirconium oxide.

The I may be titanium oxide, the X may be

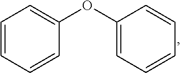 [SMILES: c1ccc(Oc2ccccc2)cc1]

### the Y may be

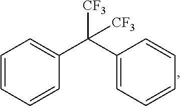 [SMILES: FC(F)(F)C(c1ccccc1)(c1ccccc1)C(F)(F)F]

and the polyamic ester may have the following chemical formula 2.

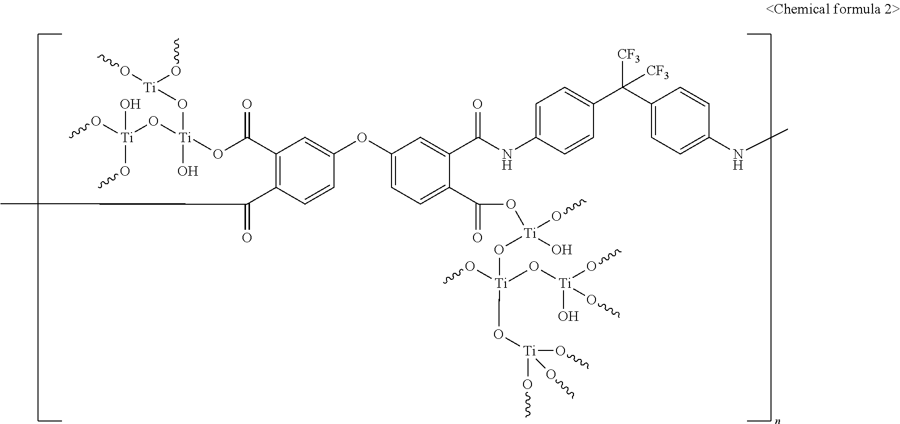

Embodiments of the inventive concept provide a method of synthesizing an organic-inorganic hybrid polyamic ester, including: synthesizing a polyamic acid by reacting a diamine monomer with a dianhydride; and synthesizing a polyamic ester of the chemical formula 1 by reacting the polyamic acid with an inorganic precursor. The dianhydride may include an aromatic or alicyclic compound. The polyamic acid may further include a number average molecular weight ranging from 500 to 100,000 g/mol.

Synthesis of the polyamic acid may include dissolving the diamine monomer and the dianhydride into a first solvent.

The first solvent may be at least one selected from a group consisting of N,N-dimethyl acetamide, N,N-dimethyl formamide, and N-methylpyrrolidine.

The diamine monomer may include at least one selected from a group consisting of an aliphatic compound, an alicyclic compound and an aromatic compound.

The diamine monomer may be at least one selected from a group consisting of 2,2-bis(4-aminophenyl)hexafluoropropane, 4,4′-diamino octafluorobiphenyl, oxydianiline, m-phenylene diamine, 1,3-diaminopropane, and 1,2-bis(2-aminethoxy)ethane.

The dianhydride may be at least one selected from a group consisting of 4,4′-oxydiphthalic anhydride, 4,4′-4,4′-hexafluoroisopropylidene, diphthalic anhydride, 3,3′,4,4′-benzophenonetetracarboxylic dianhydride, pyromellitic dianhydride, 1,2,3,4-cyclobutanetetracarboxylic dianhydride, 1,2,3,4,-cyclopentanetetracarboxylic dianhydride, and 1,2,4,5,-cyclohaxanetetracarboxylic dianhydride.

Synthesis of the polyamic acid may be performed in an ambient of inert gas.

Synthesis of the polyamic ester may include introducing the inorganic precursor into a solution containing the polyamic acid with a catalyst.

Synthesis of the polyamic ester may include dissolving the polyamic acid and the inorganic precursor into a second solvent with a catalyst.

The second solvent may be at least one selected from a group consisting of N,N-dimethyl acetamide, N,N-dimethyl formamide, N-methyl pyrrolidine, cyclohexanone and γ-butyrolactone.

The catalyst may be at least one out of water, hydrochloric acid, nitric acid, sulfuric acid, and boric acid.

The inorganic precursor may include the following chemical formula 3.

A-O—I <Chemical Formula 3>

In the chemical formula 3, the A may be an alkyl group and the I may include at least one element out of an inorganic element and a metal element or at least one alkoxide group or oxide group combined to the element.

Embodiments of the inventive concept provide a method of fabricating a film, including: dissolving a diamine monomer and a dianhydride into a first solvent and reacting the diamine monomer with the dianhydride to synthesize a polyamic acid; introducing an inorganic precursor into a solution containing the polyamic acid or dissolving the polyamic acid and the inorganic precursor into a second solvent to react the polyamic acid with the inorganic precursor and to synthesize a polyamic ester of the following chemical formula 1; and fabricating a film including the polyamic ester on a substrate.

The film fabrication of the polyamic ester may include: coating a solution including the polyamic ester on the substrate; and performing a dry process.

The dry process may be performed at a temperature ranging from 150 to 200° C.

The method may further include heating the solution including the polyamic ester coated on the substrate and converting the polyamic ester to the corresponding polyimide to fabricate a film where the I and the polyimide are mixed.

The conversion of the polyamic ester may be performed at a temperature equal to or more than 200° C.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a graph showing a result of an experimental example according to an example of the inventive concept.

### DETAILED DESCRIPTION OF THE EMBODIMENTS

Preferred embodiments of the present invention will be described below in more detail. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Embodiments of the inventive concept provide an organic-inorganic hybrid polyamic ester including the following chemical formula 1.

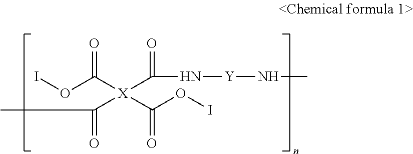

In the chemical formula 1, the X is an alicyclic compound or an aromatic compound, the Y is at least one selected from a group consisting of an aliphatic compound, an alicyclic compound and an aromatic compound, and the I includes at least one out of an inorganic element or a metal element or at least one oxide group combined to the element. The I may be at least one selected from a group consisting of oxide of an inorganic or metal element such as titanium oxide, silicon oxide and zirconium oxide. Titanium(VI) methoxide, titanium(VI) ethoxide, titanium(VI) buthoxide, zirconium(VI) ethoxide and so on can be precursors of the I.

In a preferred embodiment, in the chemical formula 1, the I may be titanium oxide, the X may be

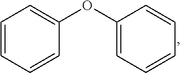 [SMILES: c1ccc(Oc2ccccc2)cc1]

### the Y may be

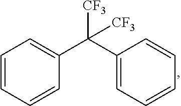 [SMILES: FC(F)(F)C(c1ccccc1)(c1ccccc1)C(F)(F)F]

and the polyamic ester may have the following chemical formula 2.

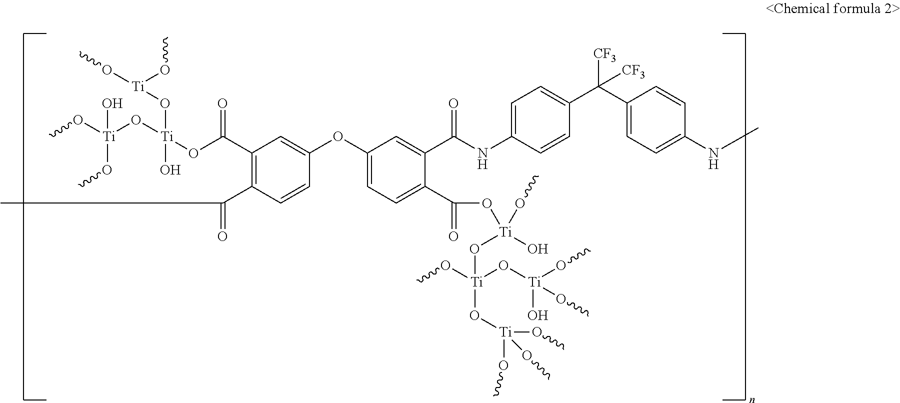

The polyamic ester can be synthesized by the following method. In a first step, a diamine monomer and a dianhydride are reacted to form a polyamic acid. In a second step, the polyamic acid is reacted with an inorganic precursor to form a polyamic ester of the chemical formula 1. The polyamic acid may further include a number average molecular weight ranging from 500 to 100,000 g/mol. The dianhydride may include an aromatic or alicyclic compound. The first step and the second step can be continuously performed.

In the first step, the polyamic acid (3) can be synthesized by reacting the diamine monomer (1) with the dianhydride (2) in a first solvent which can be dissolve the diamine monomer (1) and the dianhydride (2). This reaction can be represented as the following reaction equation 1.

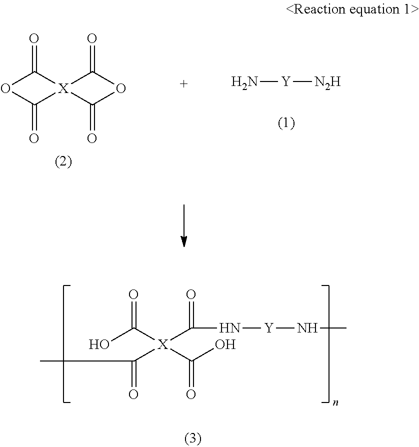

The diamine monomer (1) may include an alphatic or aromatic compound. The diamine monomer may be at least one selected from a group consisting of 2,2-bis(4-aminophenyl)hexafluoropropane, 4,4′-diamino octafluorobiphenyl, oxydianiline, m-phenylene diamine, 1,3-diaminopropane, and 1,2-bis(2-aminethoxy)ethane.

The dianhydride (2) may be at least one selected from a group consisting of 4,4′-oxydiphthalic anhydride, 4,4′-4,4′-hexafluoroisopropylidene, diphthalic anhydride, 3,3′,4,4′-benzophenonetetracarboxylic dianhydride, pyromellitic dianhydride, 1,2,3,4-cyclobutanetetracarboxylic dianhydride, 1,2,3,4,-cyclopentanetetracarboxylic dianhydride, and 1,2,4,5,-cyclohaxanetetracarboxylic dianhydride.

The first solvent can be any solvent if the solvent does not affect on the reaction between the diamine and the dianhydride monomers and can dissolve the monomers. Preferably, the first solvent may be at least one selected from a group consisting of N,N-dimethyl acetamide(DMAc), N,N-dimethyl formamide(DMF), and N-methylpyrrolidine(NMP).

Synthesis of the polyamic acid can be performed preferably in an ambient of inert gas in order to cut off inflow of moisture in air. For example, synthesis of the polyamic acid can be performed under nitrogen. In this polymerization, the concentration of the monomers may be about 10˜30 wt. %. The polymerization can be performed at about 0˜50° C. and preferably at a room temperature. The polyamic acid formed from the reaction can be a homo polymer or a copolymer. If the polyamic acid is a copolymer, the arrangement between the different monomers (of the diamine or the dianhydride) may be random. For example, the polyamic acid can be a random copolymer, an alternating copolymer, a block copolymer or a graft copolymer, or may have an arbitrary monomer arrangement.

After synthesizing the polyamic acid, a process for precipitating the polyamic acid can be performed. The polyamic acid can be precipitated in a least one out of water and alcohol. The polyamic acid powder can be re-dissolved in tetrahydrofuran (THF) and re-precipitated in the above same non-solvent for purification. The re-precipitated polyamic acid is filtered and then dried. The dry process can be performed at a temperature equal to or less than about 60° C. Before precipitation, inorganic precursor may be introduced into the polyamic acid solution to react with the polyamic acid to form the polyamic ester of the chemical formula 1.

In the second step, the polyamic acid (3) and an inorganic precursor (4) are mixed and stirred with a second solvent. The polyamic acid and the inorganic precursor are dissolved with the second solvent to react the polyamic acid with the inorganic precursor, thereby forming a polyamic ester (5) of the chemical formula 1. This reaction can be represented by the following reaction equation 2.

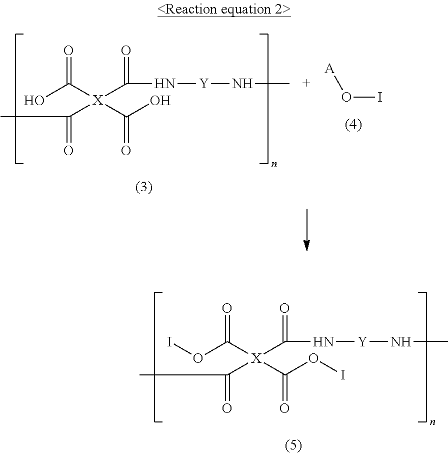

In the reaction equation 2, in the inorganic precursor (4), the A is an alkyl group and the I may include at least one element out of an inorganic element and a metal element. The I may be at least one selected from a group consisting of oxide of an inorganic or metal element such as titanium oxide, silicon oxide and zirconium oxide. Titanium(VI) methoxide, titanium(VI) ethoxide, titanium(VI) buthoxide, zirconium(VI) ethoxide and so on can be precursors of the I. Before the reaction with a carboxyl group, if the I include two or more alkoxide groups, one hydroxyl group produced from one alkoxide group reacts with a carboxyl group of the polyamic acid (3) and then other hydroxyl groups produced from the other alkoxide groups can react with a hydroxyl group produced from an alkoxide group of the same kind compound. As a result, the organic-inorganic hybrid polymer can be linear or crosslinked. Since the polyamic acid includes two carboxyl acid groups per a repeating unit, the added inorganic precursor can be preferably more than twice equivalent mol. of the carboxylic acid in the polyamic acid. The second solvent can be any solvent if the solvent does not affect on the reaction between the polyamic acid and the inorganic precursor and if the solvent can dissolve both polyamic acid and inorganic precursor. Preferably, the second solvent may be at least one selected from a group consisting of N,N-dimethyl acetamide(DMAc), N,N-dimethyl formamide(DMF), and N-methylpyrrolidine(NMP), cyclohexanone and γ-butyrolactone. More preferably, the second solvent may be DMAc. In a second solution containing the second solvent and the polyamic acid and the inorganic precursor, the solid content may be about 1˜50 wt. %.

Esterification and sol-gel reaction may occur between the polyamic acid (3) and the inorganic precursor (4). The esterification and sol-gel reaction between the polyamic acid (3) and the inorganic precursor (4) may be performed under a catalyst. The catalyst may include at least one out of water, hydrochloric acid, nitric acid, sulfuric acid, and boric acid. In the case of hydrochloric acid, the catalyst is generally 37% aqueous solution. At this time, the added amount of the aqueous solution of hydrochloric acid can be about 0.1˜10 equivalent mol. of the inorganic precursor. If necessary, the water can be more added in a range where the reaction is carried out without precipitation. The esterification and the sol-gel reaction can be carried out at a room temperature, and do not require the ambient of the inert gas as in the polyamic acid preparation. The syntheses of the polyamic acid of the reaction equation 1 and the polyamic ester of the reaction equation 2 may be continuously carried out.

A film having superior refractive index, chemical and heat resistances may be fabricated by using a solution of the polyamic ester (5).

In a method of fabricating a film according to an example of the inventive concept, the second solution including the polyamic ester is coated on a substrate and then dried to remove the second solvent, thereby forming the film.

Alternatively, in another method of fabricating a film according to another example of the inventive concept, like a method of purifying the polyamic acid, the polyamic ester is purified, re-dissolved, re-precipated, and dried and then mixed with a third solvent to make a third solution. The third solution is coated on a substrate and then dried to remove the third solvent, thereby fabricating the film. The third solvent may be at least one selected from a group consisting of N,N-dimethyl acetamide(DMAc), N,N-dimethyl formamide(DMF), N-methylpyrrolidine(NMP), cyclohexanone and γ-butyrolactone. In the third solution, the concentration of the polyamic ester may be about 1˜50 wt. %.

The dry process of removing the second solvent or the third solvent may be performed at 150˜200° C.

Alternatively, the second solution or the third solution containing the polyamic ester is coated and then heated so that the polyamic ester contained in the second solution or the third solution is converted to the corresponding polyimide to form a film composed of the I and the polyimide. The conversion of the polyamic ester may be performed at a temperature equal to or more than about 200° C.

The film may be used for various purposes. For example, the film can be applied to an LED (Light Emitting Diode) so that emitting efficiency of the LED may be increased. Alternatively, the film can be applied to glasses or lens.

### Experimental Example

### First Step: Formation of Polyamic Acid

2,2-Bis(4-aminophenyl)hexafluoropropane [6F, compound (1) in the reaction equation 3] was sublimed at about 220° C. under reduced pressure. After 4.0 g of 6F was completely dissolved in 33 mL of anhydrous DMAc at room temperature under nitrogen, 3.7 g of 4,4′-oxydiphthalic anhydride [ODPA, compound (2) in the reaction equation 3] was introduced all at once into the solution with vigorous stirring. A transparent polymer solution could be obtained after the polymerization during 24 hours. The polymer solution was diluted with anhydrous DMAc to 10% before the solution was precipitated into methanol/water (7/3, v/v) for obtaining a white and fibrous polyamic acid. For purification, a dilute tetrahydrofuran (THF) solution of the polymer was prepared and reprecipitated into methanol/water (8/2, v/v). This step was repeated several times. The white polyamic acid [polymer (3) in the reaction equation 3] powder was dried at 60° C. under vacuum to obtain 6.2 g of polyamic acid (Yield: 81%).

### Second Step: Formation of Polyamic Ester

After 0.7 g of the polyamic acid was completely dissolved in 10 mL of anhydrous DMAc at room temperature in air, 37% aqueous solution of hydrochloric acid was added drop by drop and 0.95 ml of titanium(VI) ethoxide [compound (4) in the following reaction equation 3] was slowly added to the solution with stirring. The reactions of the first step and the second step can be represented as the following reaction equation 3. The reaction was performed during 24 hours. Thereby, polyamic ester (5) of the reaction equation 3 could be obtained. The reaction solution was filtered with a 0.2 μm filter and used for forming a film.

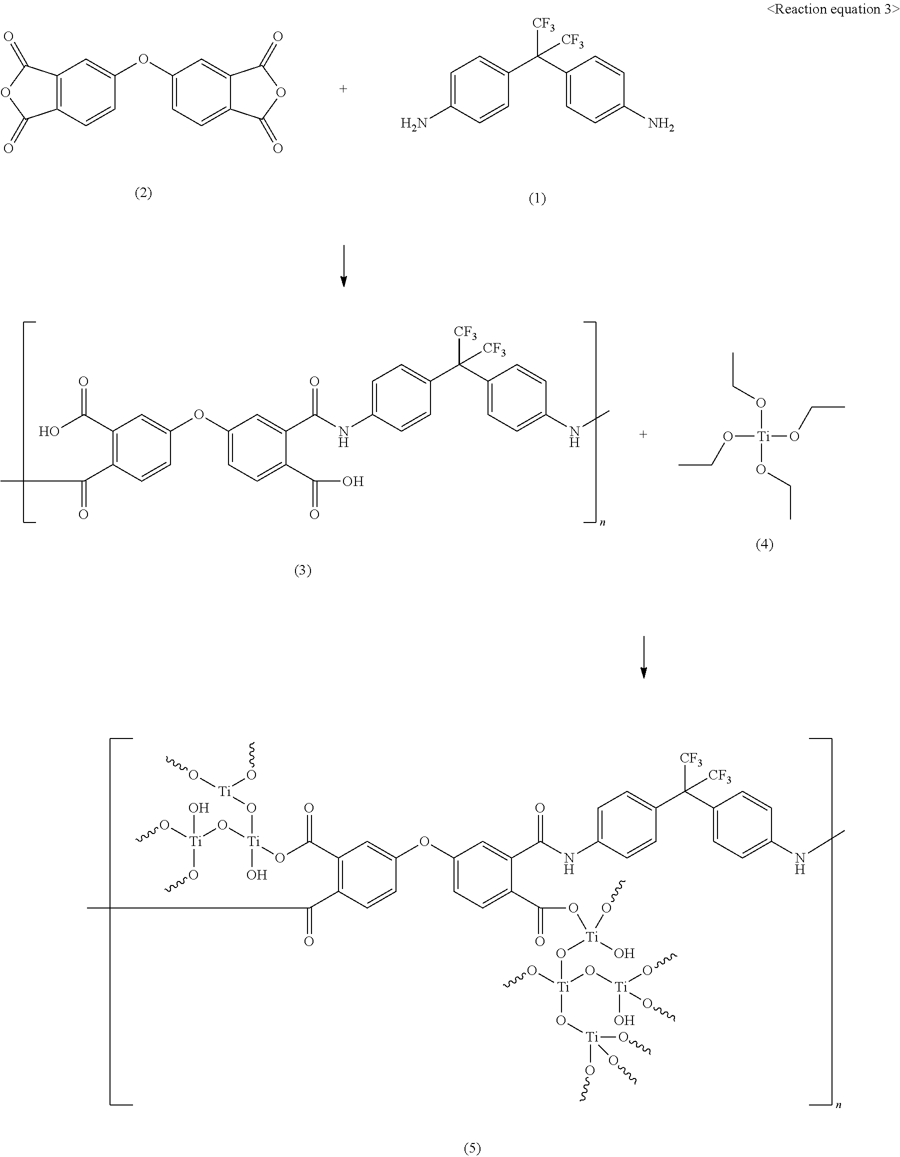

### A Third Step: Fabrication of a Film

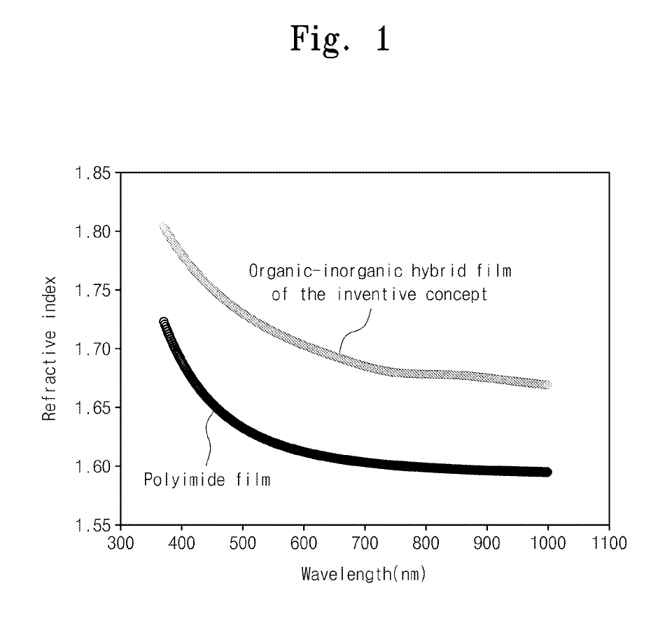

The filtered organic-inorganic hybrid polyamic ester solution was spin-coated (1500 rpm/30 seconds) on a silicon wafer and dried at 150° C. under vacuum for 24 hours to obtain a film containing the polyamic ester with a thickness of about 400 nm Refractive index of the film was measured by using an ellipsometer. The film was well fabricated. The refractive index of the film according to a light wavelength was shown in FIG. 1.

The polyamic acid made in the first step was thermally imidized at 250° C. to form the corresponding polyimide film. The refractive index of the polyimide film according to a light wavelength was shown in FIG. 1.

Referring to FIG. 1, all of the refractive indexes of the polyimide film were low at all light wavelengths in comparison with the refractive indexes of the organic-inorganic hybrid film fabricated in the present experimental example. Therefore, the film formed by the present method has a high refractive index.

According to the inventive concept, the polyamic ester is formed by chemically reacting an inorganic precursor containing inorganic and/or metal element with a polyamic acid having two carboxyl acid per a polymer repeating unit. The content of the inorganic material is relatively high, so that the polyamic ester may have high refractive index, chemical and heat resistances.

In a method of forming a polyamic ester according to the inventive concept, since a carboxyl acid is always generated when a diamine is reacted with a dianhydride and the carboxyl group has a good reactivity with an inorganic precursor, there is no limitation with selection of a monomer. Therefore, this method can be easily embodied and have a high degree of synthesis freedom.

In a method of forming a film according to the inventive concept, by using the polyamic ester steadily having an inorganic material, the film has a high content of the inorganic material and represents high refractive index, chemical and heat resistances.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. Organic-inorganic hybrid polyamic ester comprising the following chemical formula 1, 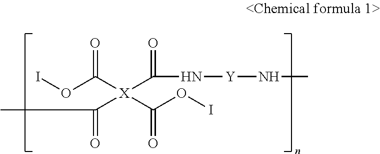
wherein, in the chemical formula 1, the X is an alicyclic compound or an aromatic compound, the Y is at least one selected from a group consisting of an aliphatic compound, an alicyclic compound and an aromatic compound, and the I is at least one out of an inorganic element or a metal element.

2. The organic-inorganic hybrid polyamic ester of claim 1, wherein the I is at least one selected from a group consisting of titanium oxide, silicon oxide and zirconium oxide.

3. The organic-inorganic hybrid polyamic ester of claim 1, wherein the I is titanium oxide, the X is 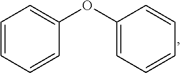 [SMILES: c1ccc(Oc2ccccc2)cc1]
the Y is 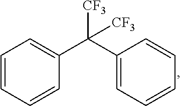 [SMILES: FC(F)(F)C(c1ccccc1)(c1ccccc1)C(F)(F)F]
and the polyamic ester has the following chemical formula 2,

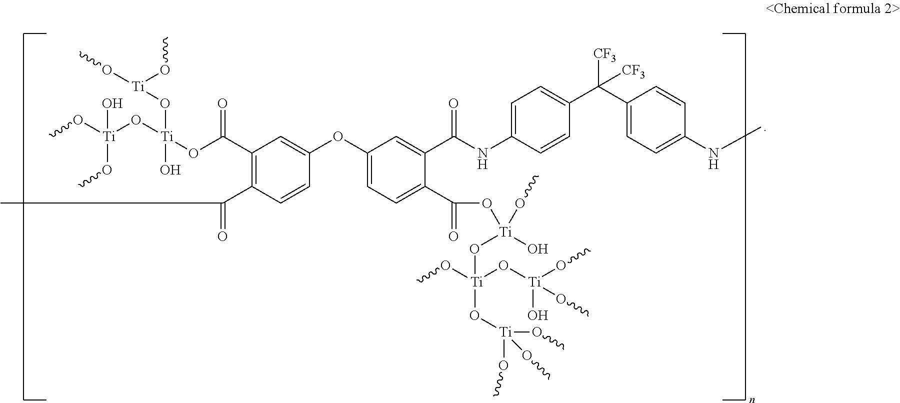

4. A method of synthesizing an organic-inorganic hybrid polyamic ester, comprising:
synthesizing a polyamic acid by reacting a diamine monomer with a dianhydride; and
synthesizing a polyamic ester of the following chemical formula 1 by reacting the polyamic acid with an inorganic precursor, 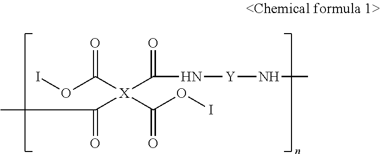
wherein, in the chemical formula 1, the X is an alicyclic compound or an aromatic compound, the Y is at least one selected from a group consisting of an aliphatic compound, an alicyclic compound and an aromatic compound, and the I is at least one out of an inorganic element or a metal element,
wherein the dianhydride includes an aromatic or alicyclic compound.

5. The method of claim 4, wherein the polyamic acid includes a number average molecular weight ranging from 500 to 100,000 g/mol.

6. The method of claim 4, wherein the synthesizing of the polyamic acid comprises dissolving the diamine monomer and the dianhydride into a first solvent.

7. The method of claim 6, wherein the first solvent is at least one selected from a group consisting of N,N-dimethyl acetamide, N,N-dimethyl formamide, and N-methylpyrrolidine.

8. The method of claim 4, wherein the diamine monomer comprises at least one selected from a group consisting of an alphatic compound, an alicyclic compound and an aromatic compound.

9. The method of claim 8, wherein the diamine monomer is at least one selected from a group consisting of 2,2-bis(4-aminophenyl)hexafluoropropane, 4,4′-diamino octafluorobiphenyl, oxydianiline, m-phenylene diamine, 1,3-diaminopropane, and 1,2-bis(2-aminethoxy)ethane.

10. The method of claim 4, wherein the dianhydride is at least one selected from a group consisting of 4,4′-oxydiphthalic anhydride, 4,4′-4,4′-hexafluoroisopropylidene, diphthalic anhydride, 3,3′,4,4′-benzophenonetetracarboxylic dianhydride, pyromellitic dianhydride, 1,2,3,4-cyclobutanetetracarboxylic dianhydride, 1,2,3,4,-cyclopentanetetracarboxylic dianhydride, and 1,2,4,5,-cyclohaxanetetracarboxylic dianhydride.

11. The method of claim 4 wherein the synthesizing of the polyamic ester comprises introducing the inorganic precursor into a solution containing the polyamic acid with a catalyst.

12. The method of claim 11, wherein the catalyst is at least one out of water, hydrochloric acid, nitric acid, sulfuric acid, and boric acid.

13. The method of claim 4, wherein the synthesizing of the polyamic ester comprises dissolving the polyamic acid and the inorganic precursor into a second solvent with a catalyst.

14. The method of claim 13, wherein the second solvent is at least one selected from a group consisting of N,N-dimethyl acetamide, N,N-dimethyl formamide, N-methylpyrrolidine, cyclohexanone and γ-butyrolactone.

15. The method of claim 4, wherein the inorganic precursor comprises the following chemical formula 3,
A-O—I <Chemical formula 3>
wherein, in the chemical formula 3, the A is an alkyl group and the I comprises at least one element out of an inorganic element and a metal element or at least one alkoxide group or oxide group combined to the element.

16. A method of fabricating a film, comprising:
dissolving a diamine monomer and a dianhydride into a first solvent and reacting the diamine monomer with the dianhydride to synthesize a polyamic acid;
introducing an inorganic precursor into a solution containing the polyamic acid or dissolving the polyamic acid and the inorganic precursor into a second solvent to react the polyamic acid with the inorganic precursor and to synthesize a polyamic ester of the following chemical formula 1; and
forming a film comprising the polyamic ester on a substrate, 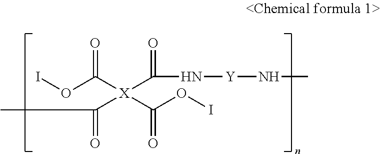
wherein, in the chemical formula 1, the X is an alicyclic compound or an aromatic compound, the Y is at least one selected from a group consisting of an aliphatic compound, an alicyclic compound and an aromatic compound, and the I is at least one out of an inorganic element or a metal element.

17. The method of claim 16, wherein the forming of the film comprising the polyamic ester, comprises:
coating a solution comprising the polyamic ester on the substrate; and
performing a dry process.

18. The method of claim 17, wherein the dry process is performed at a temperature ranging from 150 to 200° C.

19. The method of claim 17, further comprising heating the solution comprising the polyamic ester coated on the substrate and converting the polyamic ester to the related polyimide to fabricate a film where the I and the polyimide are mixed.

20. The method of claim 19, wherein the conversion of the polyamic ester is performed at a temperature equal to or more than 200° C.
